(19) United States
(12) Patent Application Publication
(10) Pub. No.: US 2026/0269860 A1
(43) Pub. Date: Sep. 10, 2026

(54) DIRECT ACCESS DATA HUB

(71) Applicant: Atlantic Signal, LLC, Topeka, KS (US)

(72) Inventors: Randall Hedrick, Topeka, KS (US); Matthew Alves, Topeka, KS (US); Tyler McClellan, Topeka, KS (US)

(73) Assignee: Atlantic Signal, LLC, Topeka, KS (US)

(21) Appl. No.: 19/559,451

(22) Filed: Mar. 6, 2026

Related U.S. Application Data
(60) Provisional application No. 63/767,718, filed on Mar. 6, 2025.

(51) Int. Cl. H04B 1/401; G06F 3/16

(52) U.S. Cl. CPC H04B 1/401; G06F 3/165

(57) ABSTRACT

A direct access data hub system is disclosed for centralized control of multiple radio transceivers in a wearable configuration. The system includes a tactile controller configured to provide independent volume, channel, and talkgroup selection inputs for two or more radios, and a hub configured to interface with the controller and the radios. The hub serves as a centralized interconnection unit that coordinates transmission of control signals to the radios and may further interface with one or more external electronic devices. In some embodiments, the hub supports multiple communication interfaces and selectively routes data and video between connected radios and devices. The system may further include controlled power distribution and passthrough charging functionality. The controller and hub may operate independently of an external computing device, or may operate in conjunction with such as device through a software interface.

### CROSS REFERENCE TO RELATED APPLICATIONS

This application claims the benefit of U.S. Provisional Patent Application Ser. No. 63/767,718, filed on Mar. 6, 2025, which is hereby incorporated by reference in its entirety.

### BACKGROUND OF THE INVENTION

The present invention relates generally to body-worn communication equipment and, more particularly, to a wearable direct access data hub configured to interface with one or more radio transceivers and associated electronic devices.

Military personnel, law enforcement officers, emergency responders, and other field operators frequently rely on portable radio transceivers for voice and data communications. Such devices are generally known for their reliability, portability, and ability to operate in environments where conventional cellular or wired communication systems may be unavailable or impractical.

However, portable radio transceivers are produced in a wide variety of configurations. Different manufacturers provide differing user interfaces, control schemes, and feature sets. For example, some radios utilize push-button channel selection, others employ rotary preset knobs, and others implement menu-driven digital interfaces and touch screen controls. Volume control mechanisms likewise vary among devices, with some devices using traditional rotary controls, others using slider controls, and others using touch screen or other control interfaces. As a result, even radios capable of communicating over compatible frequencies may present entirely different physical control layouts and operational behaviors.

In actual use, field operators often deploy multiple radios simultaneously, each potentially configured to operate on different frequencies, nets, or talkgroups associated with different agencies or operational groups. For example, a single operator may be required to monitor military communications, law enforcement channels, and emergency response networks during coordinated operations. These radios are often positioned and attached to the rear or side portions of a vest or harness for load balancing and accessibility reasons, which can make direct manipulation of individual radio controls difficult or impractical.

Furthermore, modern field operations may include additional electronic devices, such as end user devices (EUDs), computing devices, network equipment, or video sources, which may interface with the various radios or tactical networks being used for situational awareness and data exchange. Integration of multiple radios and associated devices can present challenges related to control coordination, device interfacing, cable management, and power distribution.

Thus, it can be seen that there remains a need in the art for improved systems and devices that enable centralized control of multiple radio transceivers and associated devices while reducing the need for an operator to directly interact with the individual radios themselves and improving operational efficiency in field environments.

### SUMMARY OF THE INVENTION

The present invention relates to a direct access data hub system configured to interface with one or more radio transceivers and one or more associated electronic devices to provide centralized control, data routing, and power management in a field deployable configuration.

In one exemplary embodiment, the system includes a direct access data hub with a wearable controller having grouped tactile controls for adjusting volume, selecting channels or presets, and selecting nets or talkgroups associated with one or more connected radio transceivers. The tactile controls are configured to allow rapid manipulation without requiring visual confirmation, thereby improving operability in dynamic environments.

The data hub is preferably configured to interface with first and second radio transceivers and may further interface with one or more additional electronic devices. The hub may include multiple ports arranged to facilitate organized cable routing and balanced load distribution when worn on a vest or other support structure.

In one embodiment, the direct access data hub is operable to control one or more radio transceivers independently of an associated end user device (EUD). In other embodiments, the hub may be interfaced with an EUD to provide expanded configuration, monitoring, or control functionality.

The system may further be configured to interface with external devices through one or more communication interfaces, including serial interfaces, universal serial bus (USB) interfaces, network-based interfaces, or transistor-transistor logic (TTL) interfaces. Such interfaces preferably allow connection to computing devices, network equipment, video sources, or other peripheral devices.

In some embodiments, the system may provide passthrough power capability and charging functionality for an associated end user device. Power may be distributed between the hub, connected radios, and connected devices in a controlled manner.

The direct access data hub may further be configured to route data and, in some embodiments, video, through either a tactical network pathway or a radio data pathway. This routing capability allows coordinated communication between radios and associated electronic devices.

In one exemplary embodiment, a software interface executed on an end user device may display the operational status of connected radios, device connections, selected communication interfaces, power status, and data or video routing configuration.

Thus, the present invention provides a centralized wearable communication interface capable of controlling multiple radios, interfacing with multiple devices, and managing data and power pathways while reducing the need for direct access by an operator to the controls of individual radios.

### BRIEF DESCRIPTION OF DRAWINGS

FIG. 1 is a front perspective view of a direct access data hub controller having grouped tactile volume, channel or preset, and net or talkgroup selection controls in accordance with an exemplary embodiment of the present invention.

FIG. 2 is a top view of the direct access data hub controller of FIG. 1.

FIG. 3 is a front view of a direct access data hub for control by the controller of FIG. 1 and interface to two or more radios in accordance with an exemplary embodiment of the present invention.

FIG. 3 is a block diagram of a system including a direct access data hub, a controller, first and second radio transceivers, an end user device, and one or more external devices interconnected via one or more communication interfaces in accordance with an exemplary embodiment of the present invention.

FIG. 4 is a schematic diagram showing a hub port configuration including a controller port, first and second radio ports, and one or more additional device ports arranged for balanced cable management in accordance with an exemplary embodiment of the present invention.

FIG. 5 is a front view of a wearable vest having a direct access data hub controller and an end user device attached thereto in accordance with an exemplary embodiment of the present invention.

FIG. 6 is a rear view of the wearable vest of FIG. 5 having first and second radio transceivers attached and interconnected with the direct access data hub in accordance with an exemplary embodiment of the present invention.

FIG. 7 is a block diagram depicting interfacing of the direct access data hub with one or more external devices via one or more communication interfaces including serial, USB, network-based, or TTL interfaces in accordance with an exemplary embodiment of the present invention.

FIG. 8 is a flow diagram of power management including passthrough power and charging capability in accordance with an exemplary embodiment of the present invention.

FIG. 9 is a flow diagram depicting routing of data and video through the direct access data hub via either a tactical network pathway or a radio data pathway in accordance with an exemplary embodiment of the present invention.

FIG. 10 is a representative display screen of a controller software interface executed on an end user device for configuring and monitoring operation of the direct access data hub and associated radios in accordance with an exemplary embodiment of the present invention.

### DETAILED DESCRIPTION

As required, detailed exemplary embodiments of the present invention are disclosed herein. It should be understood, however, that the disclosed embodiments are merely illustrative of the principles of the invention, which may be embodied in various and alternative forms. Thus, specific structural, functional, and operational details set forth herein are not to be interpreted as limiting, but rather as a representative basis for teaching one skilled in the art to make and use the invention and to variously employ the invention in virtually any appropriately detailed configuration. The description herein is therefore intended to encompass modifications, variations, substitutions, and equivalents that fall within the spirit and scope of the appended claims.

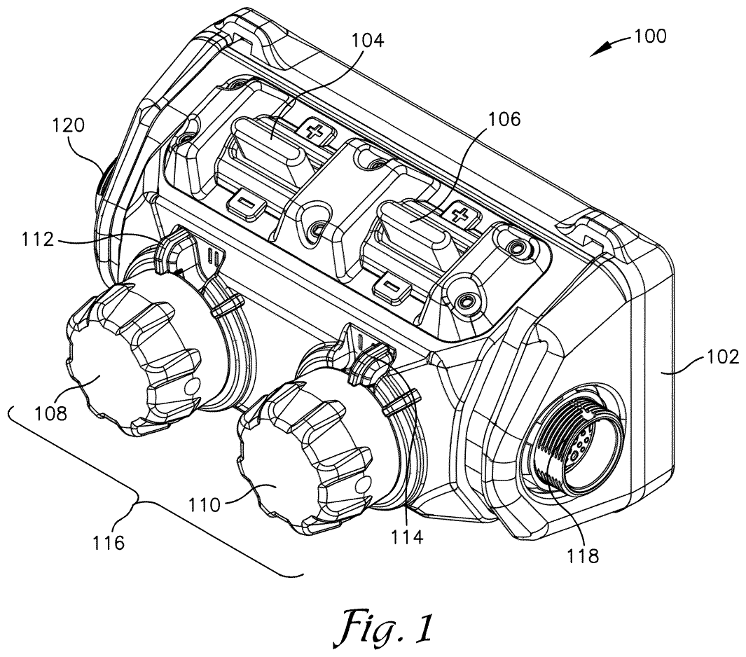

Referring generally to FIGS. 1 through 6 collectively, a direct access data hub system in accordance with an exemplary embodiment of the present invention is depicted. The system is configured to allow centralized control of one or more radio transceivers while optionally interfacing with one or more additional electronic devices in a wearable field configuration. In some embodiments, the system includes a user accessible controller positioned for convenient manual operation, and a hub positioned remotely from the controller, the hub acting as an interconnection point between the controller, connected radios, and associated devices. The system thus enables coordinated control, communication, and data exchange among multiple radios and electronic devices while reducing the need for direct manipulation of the radios themselves. The components of the system may be arranged on a vest, harness, load-bearing equipment, or other wearable support, although fixed or vehicle mounted configurations are also within the scope of the present invention.

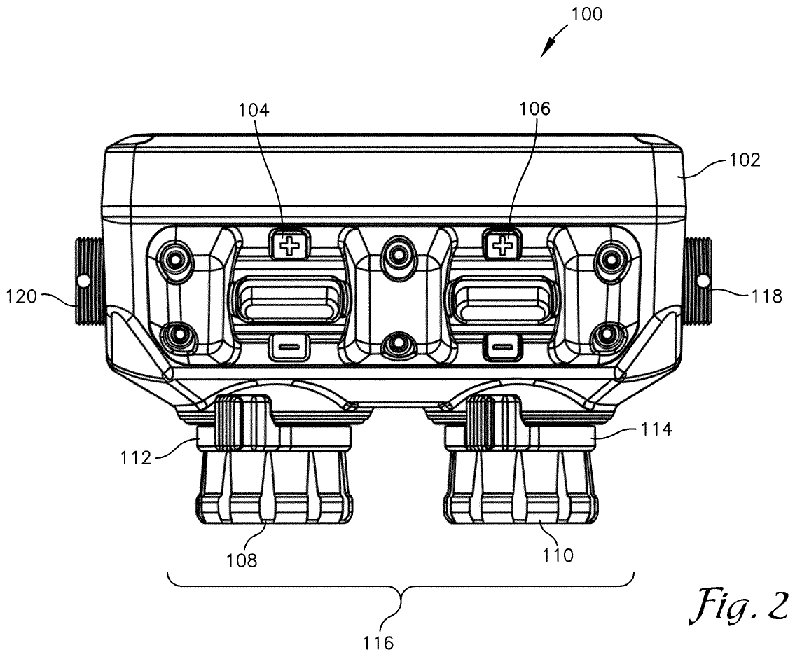

Turning first to FIGS. 1 and 2, a direct access data hub controller is shown generally as 100. The controller 100 includes a housing 102 configured to be mounted to a wearable support such as a vest, harness, plate carrier, or other load-bearing structure. In some embodiments, the housing 102 may be formed from a durable material suitable for field use and may be configured to withstand environmental conditions commonly encountered in military, law enforcement, or emergency response environments. The housing 102 may include mounting features, attachment points, or fasteners that permit secure placement on the wearable support while also allowing convenient user access to the control interfaces as described below.

The controller 100 includes first and second volume controls 104, 106 and first and second channel or preset controls 108, 110. In the embodiment depicted, each set of controls is preferably associated with a corresponding radio transceiver, thus permitting independent adjustment of multiple radios through a single user interface. The toggle volume controls 104, 106 are configured to allow incremental increase or decrease of audio output associated with the respective radio transceivers, while the channel or preset controls 108, 110 are configured to allow selection of communication channels, preset configurations, or other selectable operating modes of the respective radios. In some embodiments, the controls may be implemented as mechanical switches, rotary selectors, toggles, push buttons, or other user-actuatable mechanisms capable of generating control signals corresponding to user input. The arrangement thus allows a user to manipulate radio settings through the controller 100 without direct access to the physical controls of the radios themselves.

In some embodiments, the controller 100 may further include first and second net or talkgroup controls 112, 114 configured to allow a user to select a communication net or a talkgroup associated with each connected radio transceiver. As used herein, a “net” or “talkgroup” may refer to a logical communication grouping, virtual channel, preset configuration, or other selectable communication context supported by the respective radio. The net or talkgroup controls 112, 114 may thus permit rapid switching between different operational groups, agencies, or communication networks without requiring direct manipulation of the radio transceivers. In embodiments employing multiple radios, each net or talkgroup control may independently correspond to a different radio, enabling coordinated but distinct communication configurations across multiple networks.

As seen in FIGS. 1 and 2, the controls are preferably arranged within one or more grouped tactile control regions 116. The grouped arrangement, physical spacing, and tactile differentiation of the controls allows rapid manipulation without requiring visual confirmation by the user. In some embodiments, the controls may include distinct shapes, detents, surface textures, resistance characteristics, or travel distances that allow a user to identify the control by touch alone. This configuration allows an operator to adjust volume, change channels or presets, or switch nets while maintaining their visual focus on the surrounding environment, which is advantageous in dynamic, low-visibility, high-noise, or high-stress operational settings. The tactile feedback may further allow operation while a user is wearing gloves or other protective equipment.

The controller 100 further includes a controller connection port 118 configured to interface with a corresponding hub, as described in more detail below, and an end-user device (EUD) port 120 configured to interface with a user's EUD, if available, as also described in more detail below. The controller connection port 118 may provide electrical and/or data communication coupling between the controller 100 and the hub and the EUD port 120 may similarly provide electrical and/or data communication coupling between the controller 100 and an EUD. In some embodiments, the ports 118, 120 may include a multiconductor connector configured to transmit control signals, status information, and, in some embodiments, power, between the controller and the hub and between the controller and an EUD, respectively. The connections may be established via a detachable cable, and in some embodiments the connector smay be configured to provide secure engagement suitable for field use. The particular connector types, pin configurations, and communication formats employed may vary depending on the particular implementation and setting in which the data hub is being used.

It should be understood that, in some embodiments, the specific functionsality of the controls just described may be customized, such as via an EUD, to tailor the controls to the particular radios or or other devices being controlled. For example, in some embodiments, the channel selection switches 108, 110 may be configured to select specific talkgroups within a range of talkgroups supported by the radio.

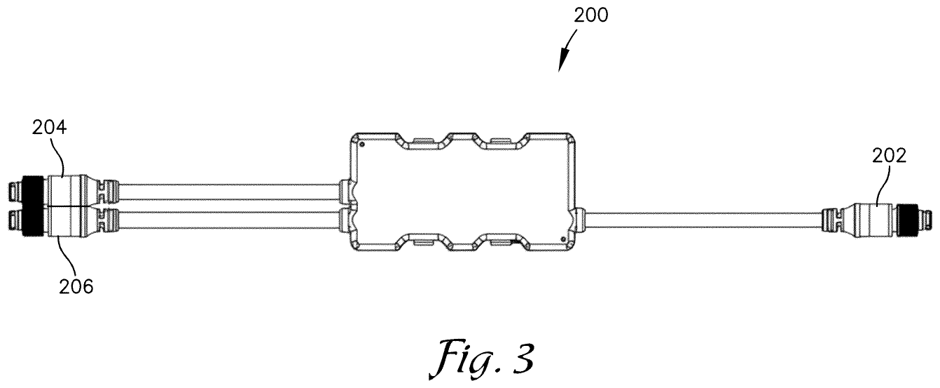

Turning to FIG. 3, a direct access data hub is depicted generally as 200. The hub 200 is configured to interface with the controller 100 via a controller port 202 and with one or more radio transceivers via dedicated radio ports 204, 206. In the embodiment shown, the hub 200 serves as a centralized interconnection unit that coordinates control signals, data communication, and power distribution between the controller, connected radios, and associated devices. The hub 200 preferably includes internal circuitry configured to receive control inputs from the controller 100 and translate or relay those inputs to the appropriate radio interfaces. The hub 200 further manages communication pathways between radios and external devices as described in greater detail below. In some embodiments the hub 200 may be integrated with the controller 100 into a single enclosure.

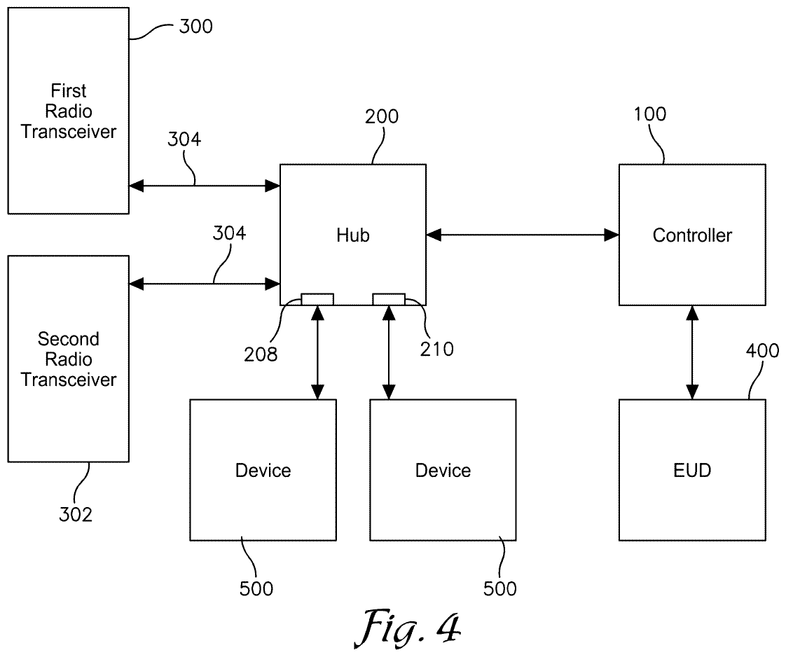

Turning to FIG. 4, a block diagram of an exemplary embodiment of the present invention, a first radio transceiver 300 and a second radio transceiver 302 are connected to the hub 200 via radio communication cables 304. While two radios are shown for illustrative purposes, it should be understood that the system may be configured to interface with one or more radios depending on operational requirements. The radio communication cables 304 may provide transmission of control signals, audio signals, data signals, and/or power between the hub 200 and the respective radios. In some configurations, the hub 200 may be positioned separately from the controller 100, such as on a rear portion of a vest or load-bearing structure, while the controller 100 is positioned on a front portion of the vest to facilitate user access. This arrangement allows a user to distribute weight as desired, reduce crowding of devices on the front of a vest, and allows organized cable routing between various system components.

The hub 200 may further include one or more additional device ports 208 and/or a multi-device port 210 configured to interface with one or more external devices 500. In some embodiments, the hub 200 may be configured to support simultaneous connection of multiple external devices through one or more of the ports 208, 210. Such external devices 500 may include computing devices, tactical network equipment, video sources, peripheral electronic devices, sensor systems, or other communication hardware depending on operational requirements. The hub 200 thus serves as a centralized connection point for coordinating communication between radios and associated electronic devices without requiring direct connections and cabling between all devices and components.

As depicted in FIG. 4, the controller 100 and hub 200 are preferably configured to permit control of one or more radio transceivers 300, 302 either with or without an associated end user device 400. In one embodiment, the controller 100 and hub 200 function together to provide direct control of connected radios independent of any external computing device. This standalone capability may be advantageous in environments where an EUD is unavailable, powered down, disconnected, or otherwise not required. In other embodiments, the system may operate in conjunction with the EUD 400 to provide expanded configuration, monitoring, or routing functionality while maintaining the ability of the controller 100 to perform essential radio control operations.

In one mode of operation, user manipulation of volume controls 104, 106 and channel or preset controls 108, 110 generates control signals that are transmitted through the hub 200 to the respective radios. The control signals may represent incremental adjustments, discrete selections, or other command inputs corresponding to the user's actuation of the controls. The hub 200 may interface with radio volume interfaces and preset or channel interfaces to accomplish corresponding changes on the radios. In some embodiments, the hub 200 may condition, format, or otherwise adapt the control signals to match the communication requirements of the respective radios. Each radio 300, 302 may thus be independently controlled through the controller 100 even if the radios use differing control schemes or communication formats.

It should be understood that control of the devices may occur independently of the EUD 400, the controller 100 and hub 200 provide direct and immediate control over connected radios without reliance on any external computing platform or device. In other embodiments, i.e., when an EUD 400 is connected to the hub 200, additional configuration, monitoring, or coordination functionality may be provided through a software interface running on the EUD. For example, operational parameters of connected radios, device status information, interface selections, or routing configurations may be displayed or adjusted through the EUD while the controller 100 continues to provide tactile control inputs. Thus, the EUD may augment system functionality, without replacing the primary control interface.

In preferred embodiments, the ports may be physically arranged and labeled to allow identification of various radio ports, controller ports, and additional device ports, thus reducing connection errors and simplifying system setup. In some embodiments, the ports may be arranged to separate radio connections from external device connections to minimize cable crossover and potential interference. It should be understood that the specific port arrangements shown are exemplary in nature, and alternative port configurations may be employed within the scope of the present invention.

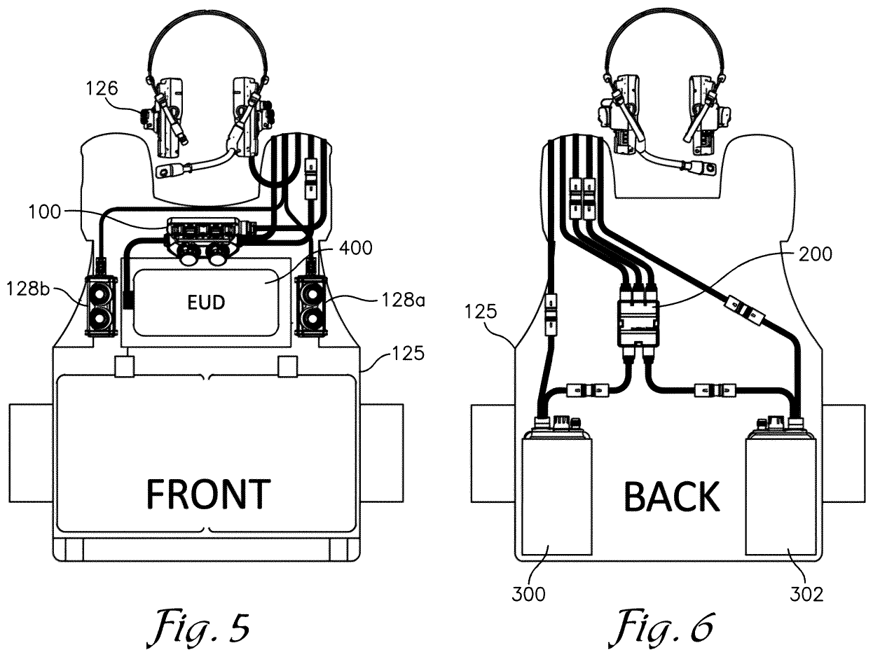

Looking to FIGS. 5 and 6, front and back views of an exemplary embodiment of a wearable configuration of the devices as described above is depicted. In the depicted embodiment, the controller 100 and an end user device (EUD) 400 are positioned on the front portion of a vest or load-bearing wearable garment 125, with the hub 200 and two radio transceivers 300, 302 positioned on a rear portion of the vest. Positioning the controller 100 on the front portion of the wearable support allows convenient manual access to the tactile controls, while locating the radios and hub on the rear portion improves weight distribution and reduces front-side congestion. The EUD 400 is mounted adjacent the controller 100 to allow coordinated operation. It should be understood that the illustrated arrangement is exemplary only, and components may be mounted at various locations depending on ergonomic preferences, mission requirements, or equipment constraints.

Additional paddle switch controllers 128a, 128b may interface with the hub 200 to allow additional controls for the radios 300, 302, and/or for control of the end user device (400) or other external devices, such as devices 500 as depicted in FIG. 4.

The depicted arrangement thus allows the user to manipulate the controls on the controller 100 while minimizing or eliminating the need to access the physical controls on the radio transceivers 300, 302 directly. In environments where radios may be mounted on the rear of a vest or otherwise positioned outside the user's immediate field of view, centralized control through the controller 100 may significantly improve efficiency and responsiveness. Audio communication may be provided through a headset 126 or other audio interface (not shown in this embodiment), and control signals generated by user actuation of the controller 100 are transmitted to the radios through the hub 200. In some embodiments, the hub 200 may receive the control input, condition or translate the signal as appropriate, and communicate corresponding control commands to the respective radio interfaces.

In some embodiments, the hub 200 and controller 100 may be integrated into a single enclosure to combine the tactile control interface and the interconnection circuitry within a unified housing. In other embodiments, the hub 200 and controller 100 may be separate components interconnected by cable(s) or other communication pathways. The communication pathway between the controller and hub may include electrical conductors, data lines, or other signal transmission media suitable for conveying control and status information. Separating the hub and controller may allow greater flexibility in component placement, weight distribution, and cable management, while integration into a single housing may reduce overall system footprint in some applications.

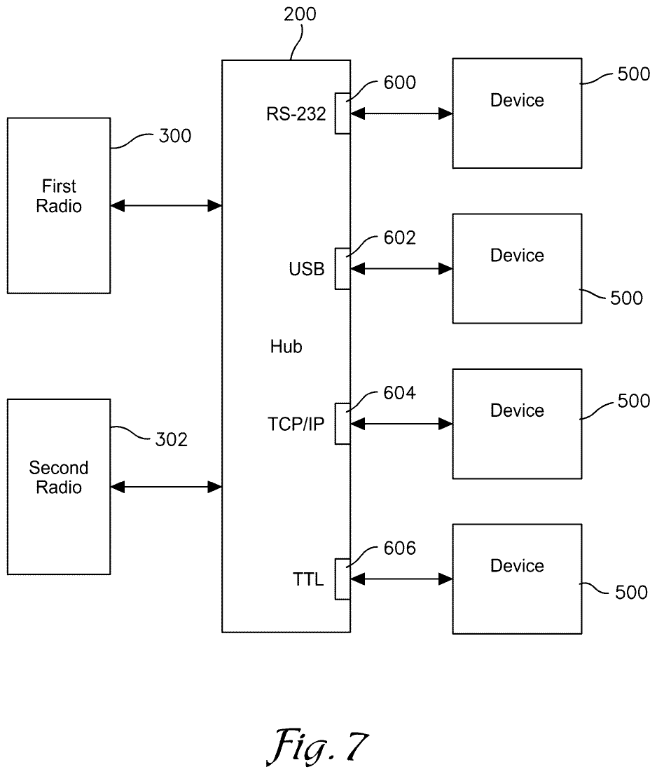

Turning now to FIG. 7, in some embodiments the direct access data hub 200 may be configured to interface with one or more external devices 500 via one or more communication interfaces. In some embodiments, the communication interfaces may include an RS-232 serial interface 600, a USB interface 602, a TCP/IP network interface 604, and/or a TTL interface 606. The hub 200 may support one or more of these interfaces simultaneously, and each interface may comprise multiple connection points of the same type (e.g., multiple, RS-232, multiple USB, etc.), or may include multiple connection points of different types (e.g., a port may support RS-232, USB, and other protocols), thus allowing connection of multiple devices using different communication standards. The selection or configuration of a particular interface may depend on the type of external device connected, the communication requirements of the system, or user preferences. It should be understood that the specific communication standards employed may vary and that the interfaces described are exemplary rather than limiting.

In some embodiments, the serial interface 600 may allow bidirectional communication with devices using serial communication standards and may be used for the purpose of transmission of control commands, status information, or other data between the hub 200 and connected devices 500. The USB interface 602 may further allow connection to computing devices or network equipment and may support data communication modes suitable for device interfacing or networking applications. The network interface 604 may allow communication using packet-based network protocols, thus allowing data exchange between radios, external devices, and associated computing platforms. The TTL interface 606 may provide electrical compatibility with some devices requiring low-voltage signaling or direct hardware level communication. It should be understood that the hub 200 may internally manage signal conditioning or formatting as necessary to accommodate the respective communication interfaces.

In one embodiment, the hub 200 may be configured to interface with multiple external devices 500 simultaneously. Such devices may include computing devices, tactical network devices, video sources, peripheral devices, sensor systems, or other electronic equipment depending on operational requirements. The hub 200 may selectively route data between connected radios 300, 302 and one or more external devices 500 via appropriate communication pathways. In some embodiments, the hub 200 may coordinate the exchange of data between radios and external devices so that information received from one device may be transmitted to another device or to one or more radios. The hub 200 thus facilitates coordinated communication among radios and associated electronic systems and devices without requiring direct interconnection between each individual component.

As just described, it can be seen that the hub 200 may act as a centralized interconnection point between radios and associated electronic devices, thus reducing the need for direct cabling between individual components and allowing fewer individual cable interconnections between devices. By consolidating the communication pathways within the hub 200, the system reduces wiring complexity and simplifies the deployment and maintenance of the communications equipment. The centralized architecture further allows easy expansion and/or reconfiguration of the system, since additional devices may simply be connected to the hub without requiring any modification of existing radio connections.

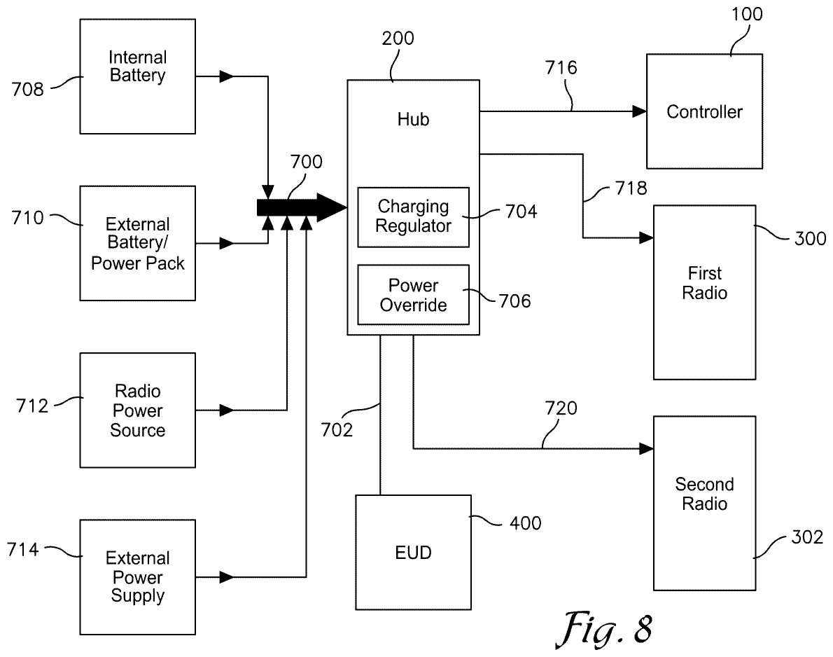

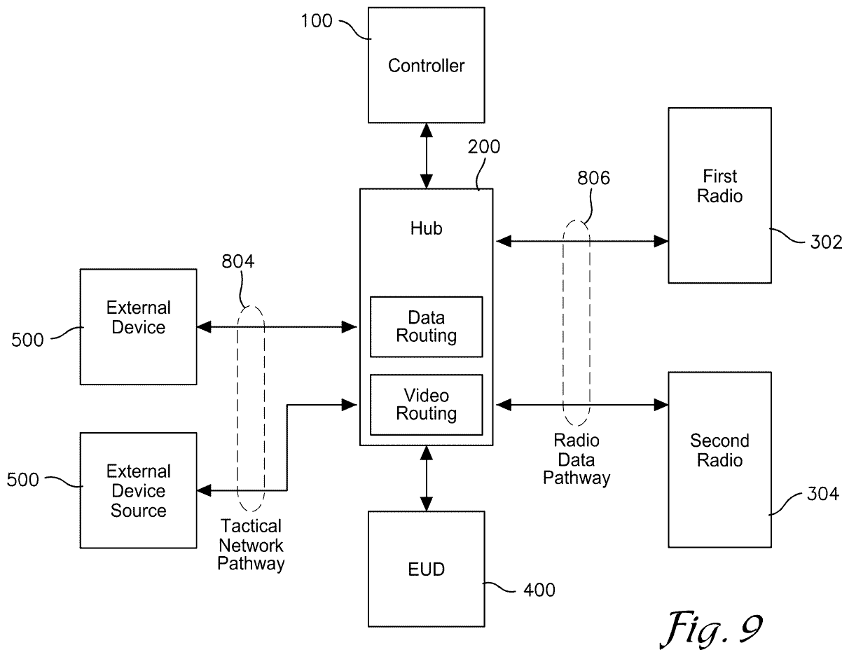

Looking to FIG. 8, in some embodiments, the system may include a power pathway 700 configured to distribute electrical power among the hub 200, controller 100, radios 300, 302, and/or connected devices. The power pathway 700 may receive electrical power from one or more sources, including an internal battery, an external battery pack, a connected radio power source, or another suitable power supply. The hub 200 may distribute power to connected components in a controlled manner, thus supporting operation of the controller, radios, and associated devices, allowing the particular power source and distribution configuration to vary depending on system requirements. In some embodiments, power may be distributed or passed-through over any port on the hub, unlike fixed port configurations known in the prior art.

In some embodiments, a pass-through power path 702 may be provided to allow electrical power to be supplied to an associated end user device (EUD) 400 or other connected device. The pass-through power path 702 allows a connected device to receive operating power from the system without requiring a separate external power connection. A charging regulator 704 may regulate voltage and current supplied to the device to support charging functionality and maintain safe operating conditions. In some embodiments, the hub 200 may monitor power demand and adjust output parameters to accommodate connected devices while ensuring stable operation of the radios and controller.

In some configurations, a power override circuit 706 allows selectively enabling or disabling some power outputs depending on the system configuration or operational requirements. The power override circuit 706 allows the hub 200 to prioritize power distribution among connected components or to temporarily suspend power delivery to a particular device. For example, power may be selectively routed from one radio or power source to an associated device while maintaining proper operating conditions for the radios and hub. In some embodiments, the override functionality may protect against excessive current draw, unintended back feed conditions, or other undesirable power states.

It should be understood that the particular source of power and the specific voltage and current levels employed may vary depending on the radios and devices being used, thus the hub 200 may be configured to accommodate differing electrical requirements associated with various radios, end user devices, or external equipment. Voltage regulation, current limiting, and other power conditioning techniques may be employed as appropriate to maintain compatibility among connected components.

Looking to FIG. 9, in some embodiments, the hub 200 may be configured to route data via a radio data routing pathway 806 and, in further embodiments, to route network data (including video, if available) tactical network pathway 804. The radio data routing pathway 806 and tactical network pathway 804 preferably allow the bidirectional transmission of information between the hub 200 and radios 300, 302 and connected external devices 500 or end user device 400. Thus, the hub 200 may selectively direct data and/or video through one or more available communication pathways depending on system configuration and operational requirements.

In one embodiment, data and/or video received from an external device 500 or an end user device 400 may be routed through the tactical network pathway 804 to the hub 200. Selection of the particular pathway to use may depend upon the operating mode of the system, the type of information being transmitted, or user configuration. Likewise, data received from one or more radios 300, 302 through the radion data pathway 806 may be routed through the hub 200 to connected external devices 500 or to the EUD 400. The hub 200 thus facilitates the coordinated exchange of information among radios and electronic devices while maintaining centralized control through the controller 100.

In some embodiments, once connections are established and configuration parameters are set, the routing functionality may operate automatically without requiring further user intervention. The hub 200 may manage the direction of data and video streams internally while the user continues to interact manually with the tactile controls of the controller 100.

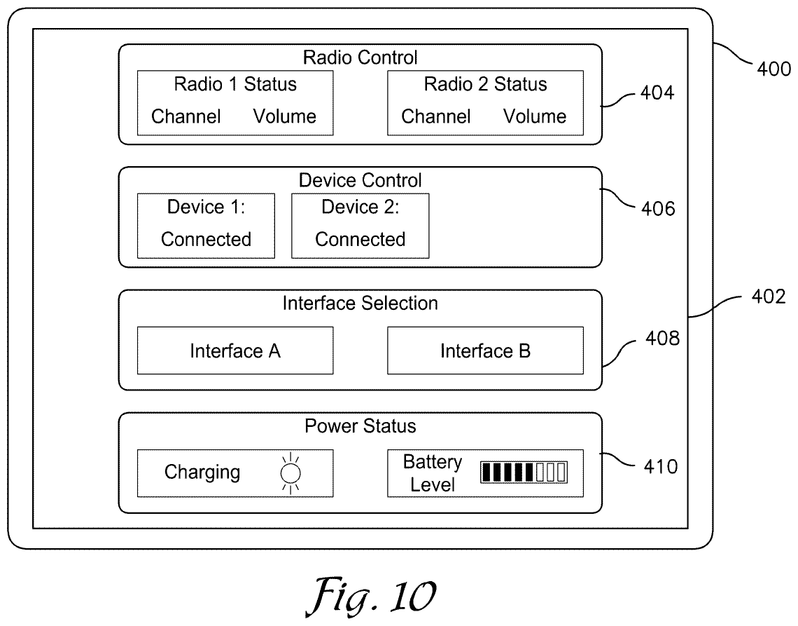

Looking to FIG. 10 in conjunction with FIG. 9, when an end user device (EUD) 400 is connected to the hub 200, a controller software interface screen 402 may be presented to the user on the EUD 400. The software interface 402 preferably provides a visual representation of operational parameters associated with the controller 100, hub 200, connected radios 300, 302, and/or external devices 500. In some embodiments, the interface is executed by an application operating on the EUD 400 and communicates with the hub 200 to retrieve status information and transmit configuration inputs. It should be understood that the graphical user interface layout as depicted in FIG. 11 is exemplary and is not intended to limit the appearance or arrangement of interface elements.

In some embodiments, the software interface 402 may include a radio control display region 404 configured to display operational parameters of one or more radios 300, 302, such as a selected channel or preset, volume settings, and other status indicators. The interface may update such information in response to signals received from the hub 200, thus providing real-time (or near real-time) status visibility. A device connection display region 406 may indicate the presence and operational status of connected external devices 500. An interface selection display region 408 provides identification or configuration of communication interfaces in use. A power status display region 410 displays information relating to passthrough power, charging status, or overall system power conditions. It should be understood that each of these display regions are exemplary in nature, and that various configurations of the user interface are within the scope of the present invention.

In some embodiments, the software interface may allow configuration or monitoring of the hub 200 while the controller 100 continues to provide tactile radio control independently of the EUD 400. The system thus supports concurrent operation in which the EUD 400 provides visibility and/or adjustment of system parameters while the controller 100 remains the primary tactile interface for radio manipulation by the user. For example, the EUD 400 may be used to configure routing preferences, monitor device status, or adjust system settings, while immediate radio control inputs are provided by the user through the controller 100.

As described herein, it can be seen that the direct access data hub system of the present invention is configured to allow a user to control two or more radio transceivers 300, 302 without requiring the user to have direct physical access to the transceivers themselves. The controller 100 provides volume controls 104, 106 and channel or preset controls 108, 110 that provide positive tactile feedback to the user, thus allowing adjustment of operational parameters through touch alone. In some embodiments, talkgroup and/or net selection controls 112, 114 on the controller further allow a user to change talkgroups or communication nets associated with connected radios without directly manipulating the radio housings. The hub 200 cooperates with the controller 100 to transmit corresponding control signals to the radios, thus centralizing radio manipulation within a wearable, field-deployable configuration.

It should be understood that while exemplary embodiments of the present invention have been described herein, the invention is not limited to the specific forms, configurations, or arrangements of components shown. For example, the number of radios, external devices, communication interfaces, and power pathways may vary, and components may be integrated or separated in various combinations. Modifications and variations may be made without departing from the spirit and scope of the invention as defined by the appended claims.

What is claimed is:

1. A direct access data hub system comprising:
a controller comprising a plurality of tactile control inputs including at least a first volume control and a first channel or preset control;
a hub comprising a controller port configured to interface with the controller and a plurality of radio ports configured to interface with two or more radio transceivers;
wherein the controller is configured to generate control signals corresponding to actuation of the tactile control inputs; and
wherein the hub is configured to transmit the control signals to respective ones of the two or more radio transceivers to adjust operational parameters of the radio transceivers without requiring direct manipulation of the radio transceivers by a user.

2. The system of claim 1, wherein the plurality of tactile control inputs further comprises a second volume control and a second channel or preset control configured to independently control a second radio transceiver.

3. The system of claim 1, wherein the plurality of tactile control inputs further comprises at least one talkgroup or net selection control configured to change a communication net associated with at least one of the radio transceivers.

4. The system of claim 1, wherein the tactile control inputs are arranged in grouped tactile control regions configured to permit operation without visual confirmation.

5. The system of claim 1, wherein the hub further comprises one or more external device ports configured to interface with one or more external electronic devices.

6. The system of claim 5, wherein the hub is configured to selectively route data between at least one of the radio transceivers and at least one of the external electronic devices.

7. The system of claim 6, wherein the hub further comprises a video routing pathway configured to transmit video signals between connected devices.

8. The system of claim 1, further comprising a power pathway configured to distribute electrical power among the hub, the controller, and the two or more radio transceivers.

9. The system of claim 8, wherein the power pathway comprises a passthrough power path configured to supply electrical power to an associated external device.

10. The system of claim 1, wherein the controller and the hub are configured to operate independently of an external computing device while optionally interfacing with the external computing device for monitoring or configuration.

11. A controller for use in a multi-radio communication system, comprising:
a housing configured to be mounted to a wearable support;
a plurality of tactile control inputs including at least a first volume control and a first channel or preset control; and
a controller connection port configured to interface with a hub;
wherein actuation of the tactile control inputs generates control signals configured to be transmitted to two or more radio transceivers via the hub.

12. The controller of claim 11, wherein the plurality of tactile control inputs further comprises a second volume control and a second channel or preset control corresponding to a second radio transceiver.

13. The controller of claim 11, wherein at least one of the tactile control inputs comprises a talkgroup or net selection control.

14. The controller of claim 11, wherein the tactile control inputs are physically differentiated to permit tactile identification without visual confirmation.

15. The controller of claim 11, wherein the housing is configured to be mounted on a front portion of a wearable garment.

16. A hub for use in a multi-radio communication system, comprising:
a controller port configured to interface with a tactile controller;
a plurality of radio ports configured to interface with two or more radio transceivers;
one or more external device ports configured to interface with one or more external electronic devices; and
internal circuitry configured to receive control signals from the tactile controller and transmit corresponding control commands to respective ones of the radio transceivers.

17. The hub of claim 16, wherein the one or more external device ports comprise at least one of a serial interface, a USB interface, a network interface, or a TTL interface.

18. The hub of claim 16, further comprising a data routing pathway configured to selectively route data between the radio transceivers and the one or more external electronic devices.

19. The hub of claim 16, further comprising a power pathway configured to distribute electrical power among connected radios and external devices.

20. The hub of claim 19, wherein the power pathway comprises a charging regulator configured to regulate voltage and current supplied to at least one connected external device.
